(19) United States
(12) Patent Application Publication
(10) Pub. No.: US 2023/0138906 A1
(43) Pub. Date: May 4, 2023

(54) TRIM CONFIGURATION OF ANALOG MODULES

(71) Applicant: TEXAS INSTRUMENTS INCORPORATED, Dallas, TX (US)

(72) Inventors: Robin Osa HOEL, Oslo (NO); Anand Kumar G, Bengaluru (IN); Praveen KUMAR N, Bengaluru (IN); Aniruddha PERIYAPATNA NAGENDRA, Bengaluru (IN); Ankitha M, Mangalore (IN)

(21) Appl. No.: 17/566,391

(22) Filed: Dec. 30, 2021

(30) Foreign Application Priority Data
Oct. 29, 2021 (IN) 202141049516

(51) Int. Cl. G06F 21/57; G06F 21/54; G06F 21/79; G06F 9/30

(52) U.S. Cl. CPC G06F 21/575; G06F 21/54; G06F 21/79; G06F 9/30101

(57) ABSTRACT

This disclosure relates to a system that includes a centralized trim controller and a non-volatile memory that includes a trim sector configured for hosting trim data for one or more peripherals. The trim controller is configured to receive, for each of the one or more peripherals, trim values of the one or more peripherals from the trim sector of the nonvolatile memory, and provide the trim values to the one or more peripherals. Some trim values are updateable by receiving a password at the trim controller. If the password is valid, a timeout counter is initiated, during which time the trim value is updateable.

### CROSS-REFERENCE TO RELATED APPLICATIONS

This application claims priority to India Provisional Application No. 202141049516, filed Oct. 29, 2021, which is hereby incorporated by reference.

### BACKGROUND

Many integrated circuits (ICs) have a mix of digital and analog modules (circuits). The operation of at least some analog modules are adjusted through use of trim data. Conventional analog modules include trim registers into which trim data is stored. Trim data is written into the trim registers in the individual analog modules from a flash memory trim sector by boot code. However, the data copy operation by the central processing unit (CPU) might be inefficient, as trim registers are spread across different modules, adversely affecting boot time. In addition, within local trim registers in analog modules, trim information is lost when the module is power gated, for example during standby modes, and requires reinitialization of the trim data upon transition from the standby mode to the active mode. Additionally, the trim registers in the analog modules may not be protected from inadvertent writes or may implement weak protection through known inline passwords, thereby being vulnerable to tampering. Further, system integrators often rely on documentation in order to use trim features. If that documentation is not provided or not followed, application-level calibration to improve module performance may not be possible.

### SUMMARY

This disclosure relates to a system that includes a centralized trim controller and a nonvolatile memory that includes a trim sector configured for including trim data for one or more analog modules. The trim controller module is configured to obtain, for each of the one or more analog modules, trim values of the one or more analog modules from a trim sector of a nonvolatile memory, wherein the trim controller is implemented in a nonswitchable power domain to provide the trim values to the one or more analog modules.

This disclosure also relates to a system having a nonvolatile memory having a trim sector, one or more analog modules, and a processor. The processor is configured to initiate a boot process of the system and, during the boot process, read trim values of the one or more analog modules from the nonvolatile memory and provide the trim values to the trim controller. The trim controller is coupled to the one or more analog modules and configured to provide the trim values to the one or more analog modules.

This disclosure also relates to a method, including receiving a write request for an application-specific trim value for an analog module, and receiving, in accordance with the write request, a password for the application-specific trim value. The method also includes, in accordance with determining that the received password is a valid password, initiating a timeout counter and updating the application-specific trim value in accordance with the write request, wherein the application-specific trim value is updateable until the timeout counter elapses.

### BRIEF DESCRIPTION OF THE DRAWINGS

For a detailed description of various examples, reference will now be made to the accompanying drawings in which:

FIG. 1 illustrates a system in which a centralized trim controller provides trim data to analog peripherals.

FIG. 2 illustrates an example memory map in which peripheral trim data is provided, according to some embodiments.

FIG. 3 illustrates an example state machine indicating various lock states for the trim registers.

FIG. 4 illustrates a flow diagram of a technique for locking and unlocking some trim registers, according to some embodiments.

FIG. 5 illustrates an example system diagram of a system for managing trim register data within a trim controller, according to some embodiments.

The same reference number is used in the drawings for the same or similar (either by function and/or structure) features.

### DETAILED DESCRIPTION

A technique is provided to include a centralized secure trim controller module. The centralized trim controller can include critical trim registers, such as those associated with infrastructure, and noncritical trim registers, such as those associated with application-specific analog modules. Trim values may be initially provided in a trim sector of a nonvolatile memory. At boot time, a processing unit can provide those trim values to the centralized trim controller, from which the trim information is made available to individual analog modules as sideband hardware signals. In some embodiments, the trim bit fields in the centralized trim controller are stored in a compacted manner to make more efficient use of storage. For example, in some embodiments, trim registers may be defined at consecutive addresses in the trim controller module. Accordingly, the embodiments described herein reduce the area needed for the trim data thereby, and facilitate a more efficient boot process.

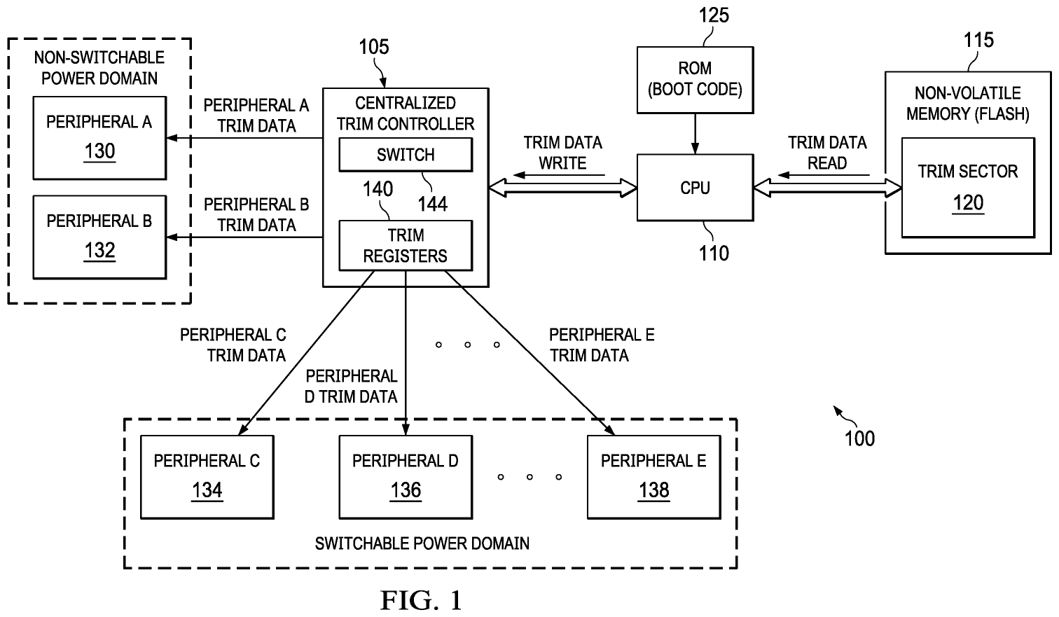

FIG. 1 depicts an example computing system 100 in which a centralized trim controller 105 is provided. According to some embodiments, initially the trim data may be stored in trim sector 120 of non-volatile flash memory 115. The trim data may be stored in a permanent or semipermanent manner. Accordingly, the trim data can survive power cycles. According to some embodiments, the boot process implemented by boot code 125 may cause the CPU 110 to, among other operations, read the trim sector 120 of the non-volatile flash memory 115. In one embodiment, the CPU 110 reads the trim values from the trim sector 120 and provides the trim values to the centralized trim controller 105. In another embodiment, the system 100 includes a direct memory access (DMA) controller (not specifically shown) to move the trim data from the trim sector 120 of the nonvolatile memory 115 to the centralized trim controller 105. The centralized trim controller 105 stores the trim data locally (i.e., in memory local to the centralized trim controller) and provides the corresponding trim values out to the various peripherals. For example, the centralized trim controller 105 may transmit the trim data as a sideband signal available to the various peripherals (as opposed to, for example, transmitting over a data connection such as a peripheral component interconnect express (PCIE) bus). In one such example, the centralized trim controller 105 includes, for each bit in the trim value, a dedicated output coupled to the respective peripheral and transmits a fixed signal at the output representing the bit of the trim value. In a further such example, the centralized trim controller 105 includes an output coupled to each peripheral and transmits the respective trim value(s) serially.

The system 100 may include various peripherals (e.g., Peripherals A-E in the example of FIG. 1). Some peripherals, such as Peripheral A 130 and Peripheral B 132 may be in a non-switchable power domain, while Peripheral C 134, Peripheral D 136, and Peripheral E 138 may be in a switchable power domain. From the trim controller 105, the trim values are provided to the peripherals, whether the peripherals are in a non-switchable power domain or a switchable power domain, according to some embodiments. In this example, the centralized trim controller 105 is in the non-switchable power domain. Peripherals in the non-switchable power domain, such as Peripheral A 130 and Peripheral B 132, will remain powered even when the system goes into a low-power state. By contrast, the peripherals that are part of the switchable power domain, such as Peripheral C 134, Peripheral D 136, and Peripheral E 138, may be switched off when the system 100 goes into a low-power state. According to some embodiments, because the trim controller 105 is implemented in a nonswitchable, “always on” power domain, the trim controller can continuously provide the trim values though a sideband signal. As such, the peripherals in a nonswitchable power domain always have access to the trim values, according to some embodiments.

While five peripherals A-E are shown in the example of FIG. 1, any number of peripherals can be included in other implementations. By way of example, peripheral A may be a bandgap voltage reference circuit. Trim data provided to a bandgap reference circuit include, for example, a resistance to adjust a current or a voltage or a bias voltage for a transistor. Peripheral B may be a low drop-out (LDO) voltage regulator. Trim data for an LDO voltage regulator includes, for example, a bias voltage for a transistor, or a resistance. Peripheral C may be an oscillator, and the trim data may adjust the frequency of oscillation. Peripheral D may be an analog-to-digital converter (ADC), and the trim data may include an adjustment to an offset for the ADC. Peripheral E may be a digital-to-analog converter (DAC), and the trim data may adjust an offset for the DAC. Any of the peripherals A-E may be any of the aforementioned peripheral types, or other types as desired.

Peripherals in a switchable power domain have access to the sideband signal containing the trim values upon entering a powered-up mode. For example, if peripheral D 136 is powered down during a standby mode, the trim data will automatically flow from the centralized trim controller 105 to the peripheral D 136 when the power domain that powers peripheral D 136 is switched on and peripheral device D returns to its fully operational mode. The trim data available from the trim controller 105 can then be used by peripheral D 136.

According to one or more embodiments, the trim controller 105 includes trim registers 140. In one example, each register is a 32-bit register. Each register includes multiple bit fields (a bit field being a contiguous subset of the bits of the register), and each bit field stores a trim value for a particular peripheral. In one embodiment, all of the trim values in a given register may be for the same peripheral. In another embodiment, a given register may store trim values for multiple peripherals. Based on the contents of the trim registers for a given peripheral, the centralized trim controller 105 generates one or more signals for that peripheral. The signal(s) contain the trim value(s) that are specific to that peripheral. For this purpose, the trim controller 105 may include a switch 144 coupled between the trim registers 140 and the outputs of the trim controller 105. The switch 144 may receive a mapping that designates which bit fields of which registers correspond to which peripheral, and the switch 144 may provide values from the various bit fields to the corresponding peripherals according to the mapping.

In some examples, the centralized trim controller continuously transmits the signal(s) regardless of whether the target peripheral is powered on or off. In the case of peripherals in the switchable power domain, such as peripheral C 134, peripheral D 136, and peripheral E 138, the signals that include the trim data for those respective peripherals are received by the peripheral when the associated power domain is powered. In the case of peripherals in the non-switchable power domain, such peripherals are continuously powered on and thus receive the trim signals from the centralized trim controller as soon as the controller transmits the signals. Each peripheral may apply its respective trim parameter to its internal circuitry upon receipt of the trim signal from the centralized power controller 105. That is, the analog module can apply the value provided into the circuitry that will change the functionality of electrical property of the analog module. As an example, the RC oscillator may have a circuitry inside that can change the frequency of the output clock based on the trim value received. In one case it can generate 48 MHz clock for trim data 0x10 while it can generate 48.1 MHz for trim data 0x15. Accordingly, the analog module circuitry interprets the received trim data and adjusts the electrical behavior.

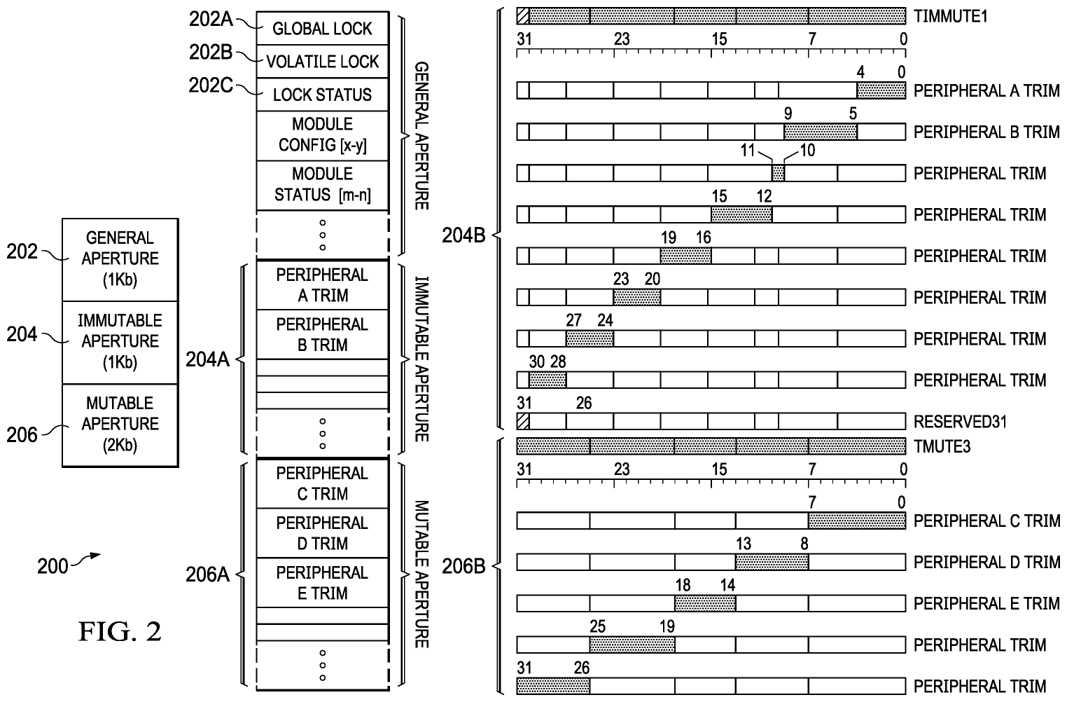

FIG. 2 depicts an example memory map of memory within the centralized trim controller containing trim values for various peripherals according to some embodiments. The trim registers may be compacted, for example by being stored in contiguous bit fields, as shown at memory map 204B and memory map 206B. By minimizing the number of registers in trim controller 105 to be written by the CPU 110 during the boot process 125, efficiency of the device boot can be improved. Said another way, because fewer write instructions are executed by the CPU to load the trim registers, clock cycles are reduced to complete a particular operation.

The memory map 200 may have subapertures, such as a general aperture 202, an immutable aperture 204, and a mutable aperture 206. The registers in the general aperture 202 may pertain to security aspects of the trim content. In the example of FIG. 2, the general aperture 202 includes a global lock register 202a, a volatile lock register 202b, and a lock state register 202c. The general aperture 202 can also include the status registers of some peripherals as an alternative to including register values in the corresponding peripheral. Accordingly, rather than having registers for smaller peripherals that require a few registers, such as 1-2 registers, those trim registers can be included by the trim controller 105 as part of its general aperture 202.

Referring still to FIG. 2, in some embodiments, the immutable aperture 204 includes critical trim values for various analog modules. For example, the critical trim values may be associated with foundational analog devices, such as power management blocks, band gap voltage references, voltage regulators, clock oscillators, etc. Those registers are housed in the immutable aperture 204 and, as such, the values within the registers cannot be changed by user application post boot. Accordingly, the immutable aperture registers are initialized during boot and then locked, as explained below.

In the example of FIG. 2, the mutable aperture 206 includes noncritical or general trim values of application-specific analog modules. These registers can be changed by user application. The general trim values are initialized based on trim sector contents 120 during boot 125 and then locked. However, a user and/or application can unlock the registers of the mutable aperture and then modify the trim values.

FIG. 2 depicts an immutable aperture 204a and a mutable register 206a as two example registers. The various trim fields for different analog modules are stored in a compact manner. For example, the trim fields may be stored back-to-back without any intermediary/unused bits. By storing the trim fields in a compact (e.g., contiguous) manner, the footprint of the trim sector 120 is reduced compared to what would have been the case if a separate memory location was assigned to store each trim value. In addition, according to some embodiments, by reducing the total number of memory locations used in the trim sector, boot time and transfer time are optimized.

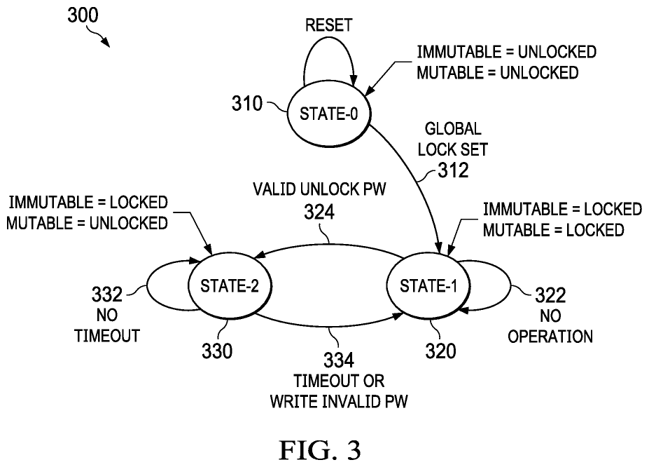

According to some embodiments, varying locking techniques may be used to manage and secure the trim values, such as a global lock and a volatile lock. FIG. 3 illustrates an example state machine diagram 300 indicating various lock states for the trim registers. The centralized trim controller 105 includes digital logic (logic gates, flip-flops, etc.) configured to implement a state machine that performs the logic of the state diagram of FIG. 3. The trim controller 105 initializes (or resets) into a reset state-0 310, where both the immutable and mutable apertures are unlocked. In one example, the global lock bit is a single bit in the global lock register 202a and that bit is cleared (e.g., logic 0) to globally unlock the registers. During state-0 310, the CPU 110 (or a DMA controller) performs the boot process, during a portion of which the trim sector 120 (which includes the trim values) from the flash memory 115 is stored into the appropriate registers of the general aperture 202, the immutable aperture 204, and/or the mutable aperture 206 of the trim controller. In addition, according to some embodiments, a global lock may be set in the general aperture so provide a locking and unlocking mechanism for the mutable and immutable apertures.

After the immutable and mutable registers are loaded, the CPU then (still as part of the boot process) then sets the global lock bit (e.g., logic 1) in the global lock register, as shown at 312. Once the boot code sets the global lock bit, the mutable aperture 206 and the immutable aperture 204 are locked and thus write-protected (state-1 320). The trim controller 105 may remain in this state until an unlock attempt is made (no operation 322).

The global lock information may be stored in the trim controller using a dual flip-flop-based redundancy mechanism. As shown, the trim controller 105 includes a first flip-flop FF1 and a second flip-flop FF2. When the global lock bit is not set, the output of the two flip flops will be 0 and 1, respectively, and the global lock will be in an unlocked state. When the global lock bit is set to 1, the output of the two flip flops will be 1 and 0, respectively, and the global lock will be in a locked state. Accordingly, if there is any one bit flip, then the state will remain as locked. For example, in some embodiments, state “01” is used for unlock, while states “10,” “00,” and “11” are used for lock states. Storing the global lock information using a double flip-flop-based redundancy can increase robustness in some embodiments.

The trim controller also includes a volatile lock (register 202b in the general aperture 202). If a user or user application wishes to modify trim values in the mutable aperture 206, the user or user application may access the mutable aperture by unlocking the volatile lock. According to some embodiments, the volatile lock register 202b is password-protected, such as by use of a 32-bit key known to the user or user application. The volatile lock register 202b register can be written with the correct password to unlock the mutable aperture 206. Failure to write the correct password into the register 202b results in the mutable aperture remaining locked. During boot, the global lock register is programmed by the boot code, which locks the mutable aperture 206 and immutable aperture 204. Upon completion of the boot process and control passes to a user-application, if required, the application can program the volatile lock, which will unlock only the mutable aperture and not the immutable aperture. As such, a valid unlock password at 324 causes the mutable aperture to be unlocked, while the immutable aperture remains, as shown at state-2 330.

Once the mutable section is unlocked, a user can update the trim values in the mutable aperture 206. In addition, according to some embodiments, the trim controller 105 includes a mutable aperture auto-locking mechanism which automatically re-locks the mutable aperture in the event the user forgets otherwise neglects to re-lock the mutable aperture. Moreover, the auto-locking mechanism acts as a security feature, reducing the risk of malware corrupting the mutable trim values, for example. Once the mutable aperture is unlocked, a counter (within the trim controller 105) begins to count. The counter may be an up-counter or a down-counter and the counter terminates upon reaching a threshold timeout value. The mutable aperture remains unlocked until the threshold timeout value is reached (unless the user has manually re-locked the mutable aperture), as shown at 334. With each write of a register in the mutable aperture 206 while it is unlocked, the counter restarts, according to some embodiments. For example, a user can continue to modify register values (332) while the mutable aperture is unlocked (at a frequency that is faster than threshold timeout value). In some embodiments, the counter may be reset with each write. When a timeout is reached, such as when the counter decrements to zero, then the mutable aperture may be relocked, as shown at 334. The counter may provide an auto-locking mechanism and can run for a predetermined number of clock counts (for example 32 counts of a clock) once the mutable region is unlocked. In some embodiments, each write may require a user to enter a password. In some embodiments, a user entering an invalid password may cause the mutable aperture to be locked, also shown at 334. In some embodiments, the global lock may still be set even as the mutable registers are unlocked via the volatile lock. As such, the trim controller will transition from state-1 320 to state-2 330 and back to state-1 320 when a user application changes one or more values in the mutable aperture 206.

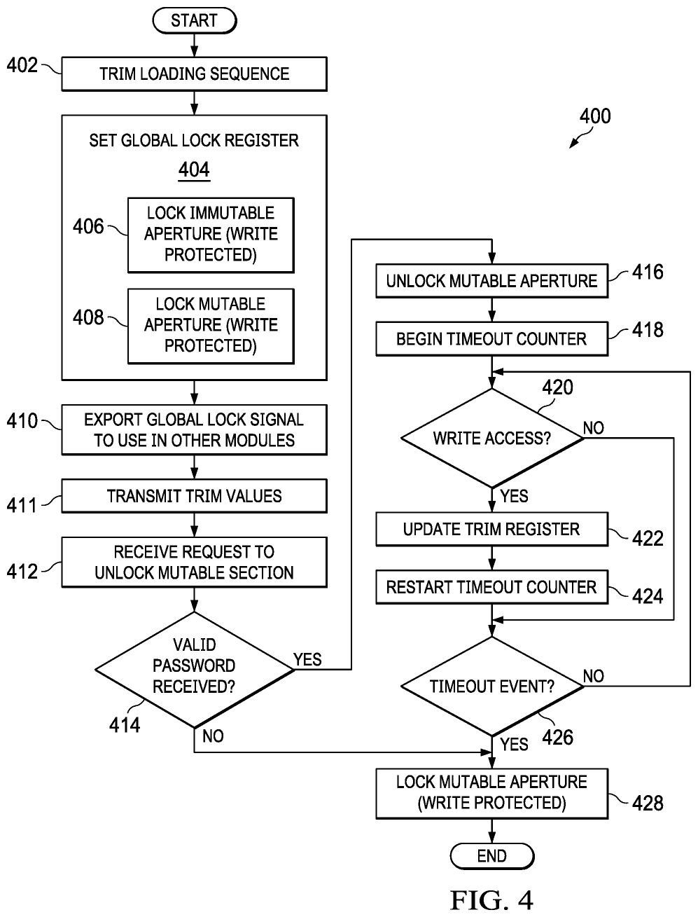

FIG. 4 illustrates a flow diagram of a technique for locking and unlocking some trim registers, according to some embodiments. Specifically, FIG. 4 depicts a technique for a centralized management of locking and unlocking trim registers, according to some embodiments. The flowchart depicts a series of steps in a particular order. However, it should be understood that the various steps may be performed in different order. Further, in some embodiments additional steps may be included, or some of the steps may be omitted. In addition, some of the steps may be performed concurrently in some embodiments. For purposes of clarity, the various steps will be described with reference to the components of FIGS. 1-3A. However, it should be understood that alternative components may be used in some embodiments.

The flowchart 400 begins at block 402, where a trim sequence is loaded. According to some embodiments, during the boot process, the CPU 110 reads trim data from the trim sector 120 of nonvolatile memory 115, and writes the trim data to the centralized trim controller 105. Then, at block 404 (and still during the boot process), the global lock register is set. In some embodiments, the global lock may be set, for example, as a bit within the trim controller 105. In some embodiments, setting the global lock may include locking an immutable aperture, as shown at 406, and locking a mutable aperture, as shown at 408. Locking the immutable and mutable aperture renders the apertures write-protected, according to some embodiments. As such, when the global lock is initially set, both immutable and mutable aperture data is write-protected.

The flowchart continues at block 410, where the trim controller 105 exports the global lock signal to use in other modules, such as peripherals 130, 132, 134, 136, and 138. According to some embodiments, the global lock signal is transmitted as a sideband signal. This global lock indication may be used by the peripherals to write-protect any of the internal test or debug registers. In some embodiments, the lock signal may be transmitted along with trim values (block 411) to the various peripherals of the system. The trim values may be transmitted at block 411 using a same sideband signal as the global lock, according to some embodiments.

The flowchart 400 continues at 412 where, following the boot process, the trim controller receives a request from a user to unlock the mutable aperture. For example, a user may wish to modify a register trim value for one of the peripherals. In some embodiments, the request may include a password. For example, a password may be programmed into the register 202b to unlock the mutable section. At 414, a determination is made by the CPU 110 as to whether the password is valid. If the password is invalid, then the flowchart 400 continues at block 428, and the mutable aperture remains locked.

Returning to block 414, if the CPU 110 determines the password to be a valid, then the flowchart 400 continues to block 416, and the mutable aperture is unlocked. Notably, the password allows the volatile lock to be unlocked, while the global lock remains locked. In this scenario, the mutable aperture can be modified, while the immutable aperture remains write-protected. In addition, at block 418, a timeout counter begins decrementing. The timeout counter may provide a timeframe in which the values of the mutable aperture may be modified before the mutable aperture is relocked.

At block 420, the trim controller determines whether a write access has been detected. As described above, in some embodiments, a user may continue writing to the trim registers until a timeout event is detected. As such, if at block 420 no write access is detected, then the flowchart continues to block 426 and a determination is made regarding whether a timeout event has occurred. As described above, the timeout event may occur when the counter decrements to zero, for example. If a timeout event does occur, then the flowchart continues to block 428, and the mutable aperture is locked and thus made write-protected.

Returning to block 420, if write access is detected, then the trim register is updated at block 422, and the timeout counter is restarted at 424. According to some embodiments, the registers in the mutable aperture may continue to be updated as long as the write access occurs (for example with a valid password) and until a timeout event occurs.

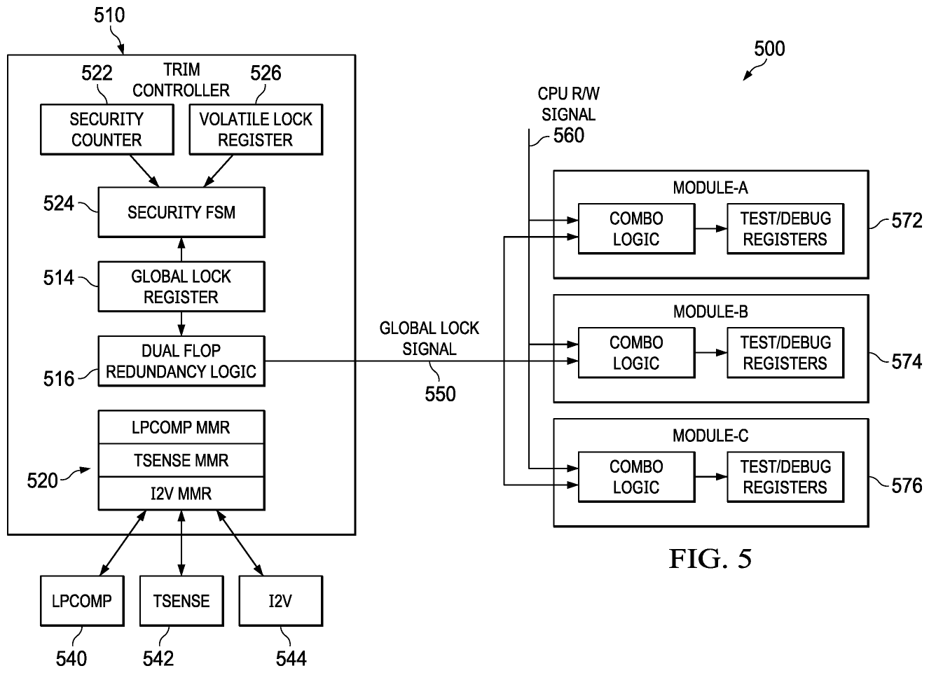

FIG. 5 illustrates an example system 500 for managing trim register data within a trim controller, according to some embodiments. In the trim controller 510 is a global lock register 514. The trim controller 510 is fed with trim values from a trim sector in external memory (external to the trim controller) and provide the trim values to the various peripherals. In some embodiments, the global lock register 514 is set by the boot code after initializing the trim registers in the trim controller 510. Once set, the registers are then locked and write-protected. The global lock register 514 may be a one-bit register in some embodiments. The locking arrangement is stored according to the dual flop redundancy logic 516 (an example of which is shown in FIG. 3B and described above). As such, even if one flop inadvertently changes the value, a redundancy is implemented. In some embodiments, some analog peripherals have trim registers that a user application should not access, for example, the debug registers or testing registers. The global lock exported from the trim controller 510 as a signal can also be used in other peripherals to write protect those registers, such as the test/debug registers of modules 572, 574, and 576. According to one or more embodiments, the global lock signal 550 may be transmitted as a signal to the peripheral modules 572, 574, and 576.

As described above, the trim controller 510 can include trim registers for some analog peripherals. For purposes of the example, a low-power comparator module 540, a temperature sensor 542, and a current to voltage converter 544 are presented. Each of these smaller analog modules are associated with a memory map register in the general aperture of trim controller 510, as shown at 520. An application can then write into the memory map register of each of the smaller analog modules 520 in the trim controller 510. That information will flow into the various analog modules, such as low-power comparator module 540, temperature sensor 542, and current to voltage converter 544, as a sideband signal. Accordingly, rather than having the registers in the peripherals, the registers can be housed in the trim controller and handle the information exchange through hardware signals. In some embodiments, it may be advantageous to include the trim registers for some peripherals within the trim controller 510 to reduce overhead in small-sized modules.

The trim controller 510 can include other miscellaneous registers related to security, such a security counter 522, security finite state machine 524, and a volatile lock register 526. As described above, the security finite state machine 524 may manage a lock status of the mutable registers based on the volatile lock register 526. In addition, the state of the security finite state machine 524 is further affected by a security counter 522, which provides a countdown which is activated upon entry of a valid password and causes the volatile lock register to lock the mutable aperture upon a timeout.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

Unless otherwise stated, “about,” “approximately,” or “substantially” preceding a value means +/−10 percent of the stated value. Modifications are possible in the described examples, and other examples are possible within the scope of the claims.

Modifications are possible in the described embodiments, and other embodiments are possible, within the scope of the claims.

What is claimed is:

1. A system, comprising:
a processor;
a nonvolatile memory comprising a trim sector;
one or more peripherals; and
a trim controller communicably coupled to the one or more peripherals and configured to:
receive, for each of the one or more peripherals, trim values of the one or more peripherals from the trim sector of the nonvolatile memory, and
provide the trim values to the one or more peripherals.

2. The system of claim 1, wherein the trim sector includes infrastructure trim registers and application-specific trim registers for the one or more peripherals.

3. The system of claim 2, wherein the trim sector further includes a global lock register and a volatile lock register.

4. The system of claim 3, wherein the global lock register is configured to initiate a global lock mode, and wherein the infrastructure trim registers and application-specific trim registers are write-protected in a global lock mode managed by the global lock register.

5. The system of claim 4, wherein the volatile lock register is configured to unlock the application-specific trim registers.

6. The system of claim 5, wherein the application-specific trim registers are updateable when the application-specific trim registers are unlocked.

7. The system of claim 6, wherein the application-specific trim registers are relocked upon a timeout occurring.

8. The system of claim 6, further including a counter configured to be initiated upon occurrence of an update to an application-specific trim register, and expiration of the counter causes the volatile lock register to be relocked.

9. The system of claim 6, wherein the volatile lock register is configured to unlock the application-specific trim registers in accordance with receiving a valid password.

10. The system of claim 1, wherein the trim controller is configured to include configuration and status registers of one or more additional peripherals.

11. A system, comprising:
a nonvolatile memory comprising a trim sector;
one or more peripherals; and
a trim controller communicably coupled to the one or more peripherals; and
a processor configured to:
initiate a boot process of the system;
during the boot process, read trim values of the one or more peripherals from the nonvolatile memory, and
provide the trim values to the trim controller,
wherein the trim controller is configured to provide the trim values to the one or more peripherals.

12. The system of claim 11, wherein the trim values are configured to be provided to the peripherals as sideband signals from the trim controller.

13. The system of claim 11, wherein the trim controller comprises an immutable aperture and a mutable aperture, wherein the immutable aperture is configured to hold infrastructure trim values for the one or more peripherals, and wherein the mutable aperture is configured to hold application-specific trim values for the one or more peripherals.

14. The system of claim 13, wherein the trim sector further comprises a global lock and wherein the global lock is configured to initiate a lock state in which the infrastructure and application-specific trim values are write-protected.

15. The system of claim 14, wherein the trim controller further comprises a mutable aperture unlock state in which the application-specific trim values are modifiable.

16. The system of claim 14, wherein the trim controller is further configured to:
export a global lock indicator to the one or more peripherals, wherein one or more internal registers of the one or more peripherals are write-protected in accordance with the exported global lock.

17. A method comprising:
receiving a write request for a trim value for a peripheral, wherein the trim value is stored in a trim controller communicably coupled to the peripheral;
receiving, in accordance with the write request, a password for the application-specific trim value; and
in accordance with determining that the received password is a valid password:
initiating a timeout counter, and
updating the trim value in accordance with the write request,
wherein the trim value is updateable until the timeout counter elapses.

18. The method of claim 17, wherein an additional trim value for the peripheral remains locked during the update of the trim value.

19. The method of claim 17, further comprising:
receiving a second write request for a second trim value for a second peripheral;
receiving, in accordance with the second write request, a second password; and
in accordance with determining that the second password is valid:
updating the second trim value in accordance with the second write request, and
restarting the timeout counter.

20. The method of claim 17, further comprising:
receiving a second write request for a second trim value for a second peripheral;
receiving, in accordance with the second write request, a second password; and
in accordance with determining that the second password is invalid, initiating a lock state of the second trim value.
